(19) United States
(12) Patent Application Publication
(10) Pub. No.: US 2008/0084014 A1
(43) Pub. Date: Apr. 10, 2008

(54) Retrofit Jig System for a Truss Assembly Table

(75) Inventors: Kieth E. Godwin, Eureka, MO (US); Gerald T. McCoombe, St. Louis, MO (US); Gregory W. Pogue, Troy, MO (US); Ferdie G. Tenshler, Hazelwood, MO (US); Jack E. Dodd JR., St. Louis, MO (US); Adam M. McClenahan, Cook Spring, AL (US)

Correspondence Address: SENNIGER POWERS LLP, ONE METROPOLITAN SQUARE, 16TH FLOOR, ST LOUIS, MO, 63102, US

(73) Assignee: MITEK HOLDINGS, INC., Wilmington, DE (US)

(21) Appl. No.: 11/864,436

(22) Filed: Sep. 28, 2007

Related U.S. Application Data
(60) Provisional application No. 60/828,007, filed on Oct. 3, 2006.

(51) Int. Cl. B27F 7/15

(52) U.S. Cl. 269/37

(57) ABSTRACT

The invention is directed toward a retrofit jig system for use with an existing truss assembly table having multiple planks extending lengthwise along the table. The jig system includes a motor and jig assembly for moving a puck lengthwise along the truss assembly table between adjacent planks of the table. A support member supports the screw between the adjacent planks. The support member is adjustable to allow the puck to move past the support member without interference.

### CROSS-REFERENCE TO RELATED APPLICATION

The present application claims priority to U.S. Provisional Application No. 60/828,007, entitled “Retrofit Jig System for a Truss Assembly Table” and filed Oct. 6, 2006, the entirety of which is herein incorporated by reference.

### BACKGROUND OF THE INVENTION

The current invention relates to a jig system for locating work pieces on a truss assembly table, and in particular, to a retrofit jig system for installation on an existing truss assembly table.

Prefabricated trusses are often used in the construction of buildings. They are cost effective, easy to use, and offer superior strength and reliability over trusses built on site. The trusses generally comprise a number of structural components, including bottom chords, upper chords arranged in a V-shaped or other configuration, and connecting webs between the chords. The chords and connecting pieces are joined together by metal connector plates which are usually pressed into the components at joints between components on both sides of the truss by a suitable press or the like.

Conventionally, the components from which the prefabricated truss is to be made are laid out on a truss table which has a jig assembly comprising multiple stops (often referred to as pucks) for setting the position of the chords. The pucks are moveable along the table to accommodate making trusses of different sizes and styles. Conventionally, the pucks are manually positioned. An operator locates the pucks by measuring a desired distance from the end of the table and manually moving the pucks to that position. The operator then secures each puck, places the truss components on the table against the pucks, and secures the components together. The process is repeated for each truss. U.S. Pat. No. 5,085,414 (Weaver) discloses an example of a truss table with manually positioned pucks. Many of these traditional truss tables are currently in operation. But as can be seen, they are very time intensive to use.

To improve efficiency, a laser projection system may be used with the traditional truss table to more accurately position the pucks on the truss table. An example is shown in U.S. Pat. No. 6,317,980 (Buck, III). The laser projects an image of a desired truss on the work surface of the table and the pucks are then moved to the desired position without measuring. While these systems improve efficiency and accuracy in truss assembly, they do not eliminate the time intensive step of manually positioning the pucks.

Newer truss tables employ motorized jig assemblies to automatically move the pucks along the truss table. An example is shown in co-owned U.S. Pat. No. 5,854,747 (Fairlie). Another example is shown in U.S. Pat. No. 6,712,347 (Fredrickson et al). These tables are specially formed to receive the motorized components of the jig assemblies under the tables. Computer programs may then be used to position the pucks as desired. These assemblies significantly increase speed and efficiency of positioning pucks along the truss table and thus of truss production. But the initial capital investment required to obtain a new truss table and automated jig assembly can be very large. Therefore, it would be beneficial to provide an after-market motorized jig assembly that can be installed on an existing traditional truss table to automate truss production without requiring expenditures to obtain a new table and jig assembly.

### SUMMARY OF THE INVENTION

The invention is directed generally to a jig system for use with a truss assembly table having multiple planks extending lengthwise along the table. In one aspect, the jig system generally comprises at least one stop arranged for lengthwise movement along the truss assembly table between adjacent planks of the table. A support member is mounted on the truss assembly table for supporting the stop between the adjacent planks. The support member is adjustable to allow the stop to move past the support member without interference.

In another aspect, a truss assembly apparatus comprises a jig assembly table having multiple planks fixedly attached to a frame and a retrofit jig system mounted on the truss assembly table. The jig system is mounted without removing planks from the table and generally comprises a stop member arranged for lengthwise movement along the truss assembly table between adjacent planks of the table. A drive member is mounted on the table for moving the stop member along the table. A support member is mounted on the truss assembly table for supporting the drive member and stop member.

In another aspect, a method for retrofitting a truss assembly table with a jig system generally comprises the steps of mounting a drive member on the table and a stop member moveable by the drive member on the table, and mounting a support on the table for supporting the drive member.

In still another aspect, a method of retrofitting an existing truss table with a powered jig assembly generally comprises mounting the powered jig assembly on the table under existing planks of the table.

Other features of the invention will be in part apparent and in part pointed out hereinafter.

### BRIEF DESCRIPTION OF THE DRAWINGS

FIG. 1 is a top perspective of a truss assembly apparatus of the invention;

FIG. 2 is a top plan thereof;

FIG. 3 is a bottom perspective of the truss assembly apparatus;

FIG. 4 is a fragmentary bottom plan view of the truss assembly apparatus;

FIG. 5 is a fragmentary perspective of FIG. 1 with portions of planks of a truss table of the truss assembly apparatus broken away to show jig assemblies;

FIG. 6 is a perspective of a jig assembly of the invention;

FIG. 7 is a perspective of a puck of the jig assembly;

FIG. 8 is an exploded perspective of the puck of FIG. 7;

FIG. 9 is a perspective of an adjustable screw support of the jig assembly;

FIG. 10 is an exploded perspective of the support of FIG. 9;

FIG. 11 is a perspective of a motor of the jig assembly mounted on a frame of a truss table with only a fragmentary portion of the frame illustrated;

FIG. 11A is a perspective similar to FIG. 11 from a lower angle and with a perimeter transverse beam removed therefrom;

FIG. 12 is an enlarged fragmentary perspective of the jig assembly;

FIG. 13 is an enlarged fragmentary perspective of the puck moving along the screw toward the adjustable screw support;

FIG. 14 is a perspective similar to FIG. 13 with the puck moving into engagement with an engagement block of the adjustable screw support;

FIG. 15 is a perspective similar to FIG. 14 with the puck moving over the adjustable screw support and pushing the engagement block downward to provide room for the puck to move past the screw support;

FIG. 16 is a perspective similar to FIG. 15 with the puck continuing to move past the adjustable screw support;

FIG. 17 is a perspective similar to FIG. 16 illustrated continued movement of the puck past the adjustable screw support with the engagement block beginning to move upward as the puck passes; and

FIG. 18 is a perspective similar to FIG. 17 but with the puck past the adjustable screw support and the engagement block returned to its position supporting the screw.

Corresponding reference names indicate corresponding parts throughout the views of the drawings.

### DETAILED DESCRIPTION OF THE DRAWINGS

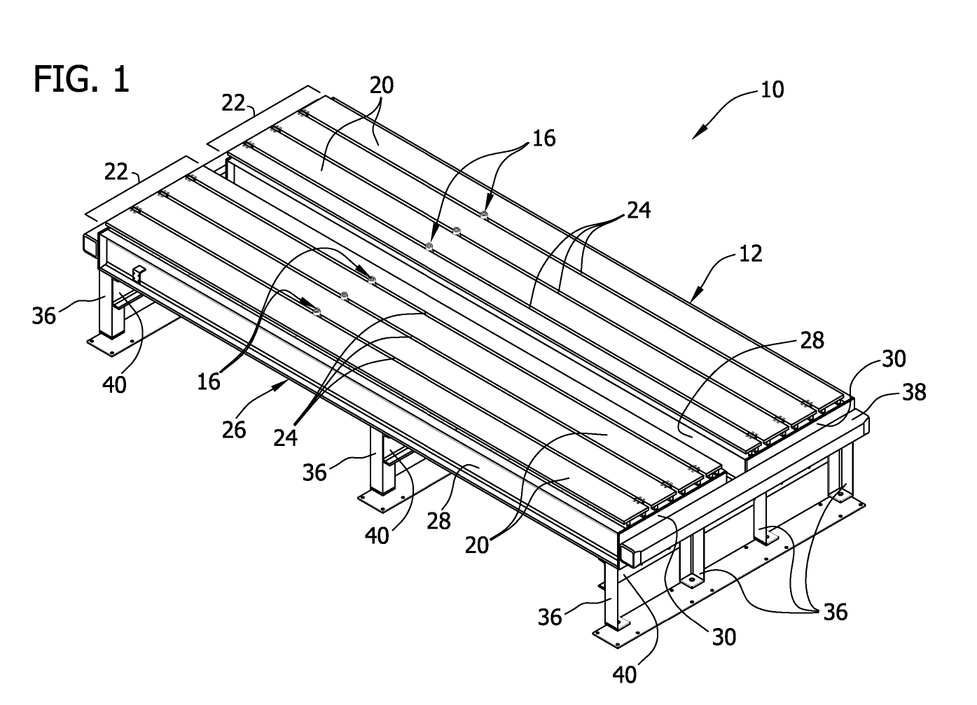

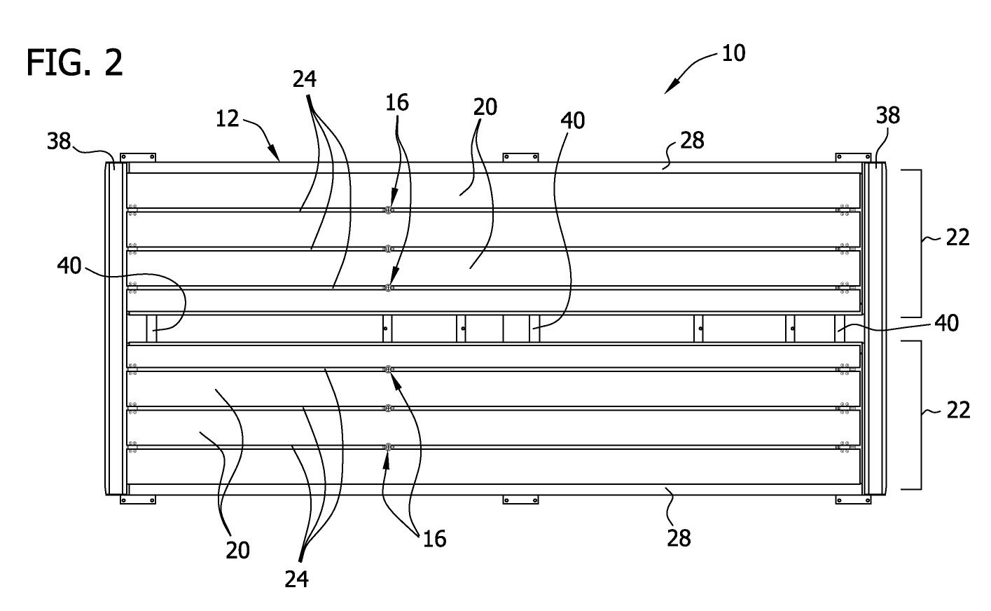

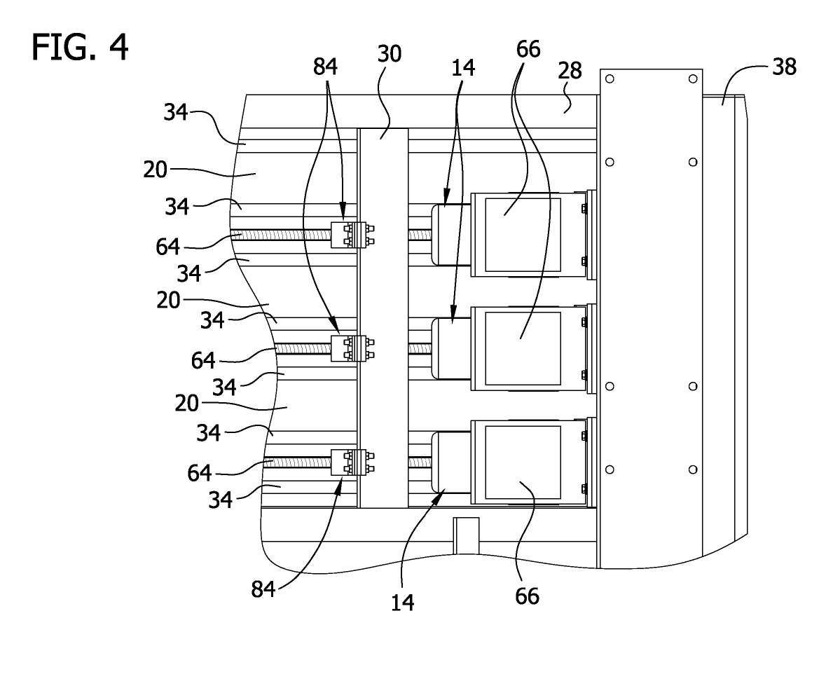

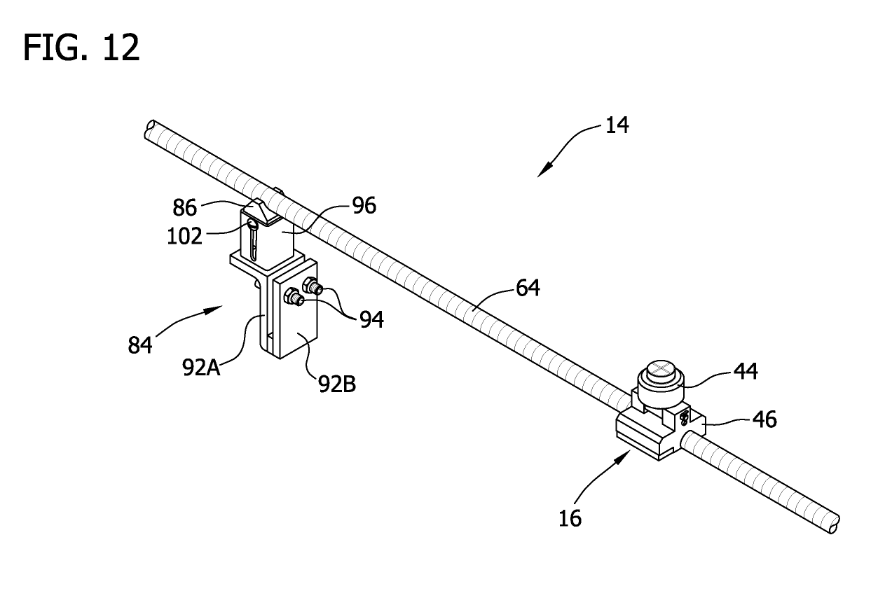

Referring now to the drawings and in particular to FIGS. 1-5, one embodiment of a truss assembly apparatus according to the present invention is generally indicated at 10. The apparatus includes a truss table, generally indicated at 12, on which structural members, such as wooden boards (not shown), and connector plates (not shown) may be positioned at a desired configuration for assembly to form, for example, a truss. Jig assemblies, generally indicated at 14 in FIGS. 4, 6 and 12-18, are mounted on the table 12 for use in locating structural members in the desired location to form a desired truss. Stop assemblies, generally indicated at 16, of the jig assemblies 14 are moveable along the table 12 to provide guides for positioning the structural members. In the illustrated embodiment, the stop assembly 16 may be broadly considered a “stop” and can include any number of distinct components.

Referring still to FIGS. 1-3, the illustrated truss table 12 is of the type generally known in the art and may include one manufactured by MiTek Industries, Inc. of Chesterfield, Mo. As shown in FIG. 1, the illustrated table 12 has a plurality of parallel, elongate panels, or planks 20 extending lengthwise across the table. The planks 20 are arranged in two spaced apart mirror image groupings 22. Adjacent planks 20 of each grouping 22 are spaced apart widthwise to define slots 24 for receiving one of the stop assemblies 16, as will be explained below. Upper surfaces of the planks 20 are substantially planar and provide a working surface for placement of the structural members. Rather than extending longitudinally along the table, the planks 20 could extend transversely across the length of the table if desired.

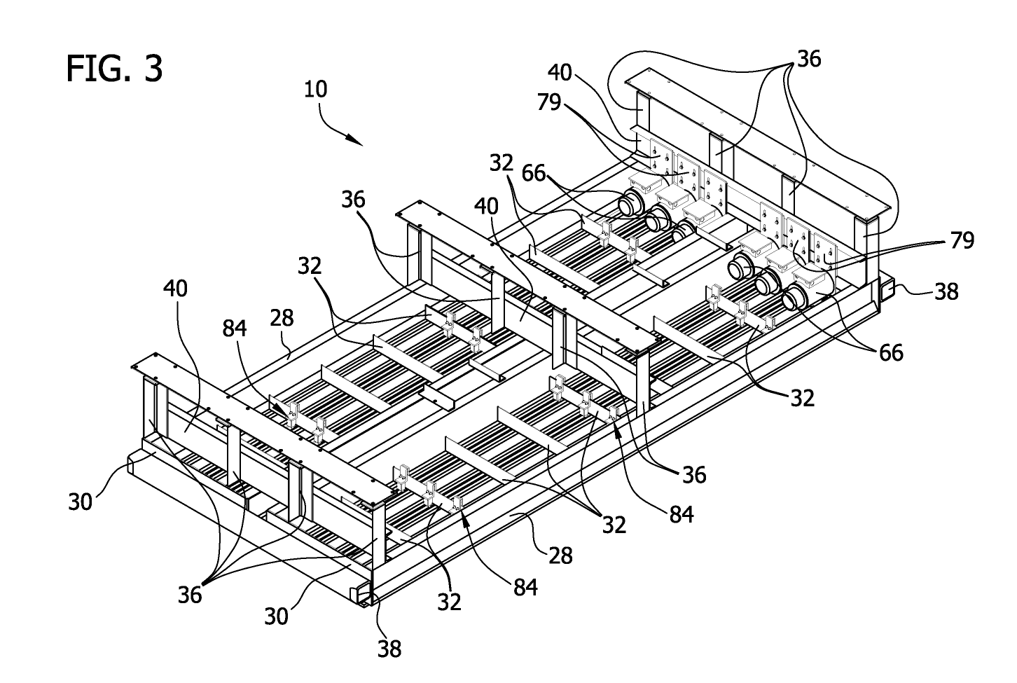

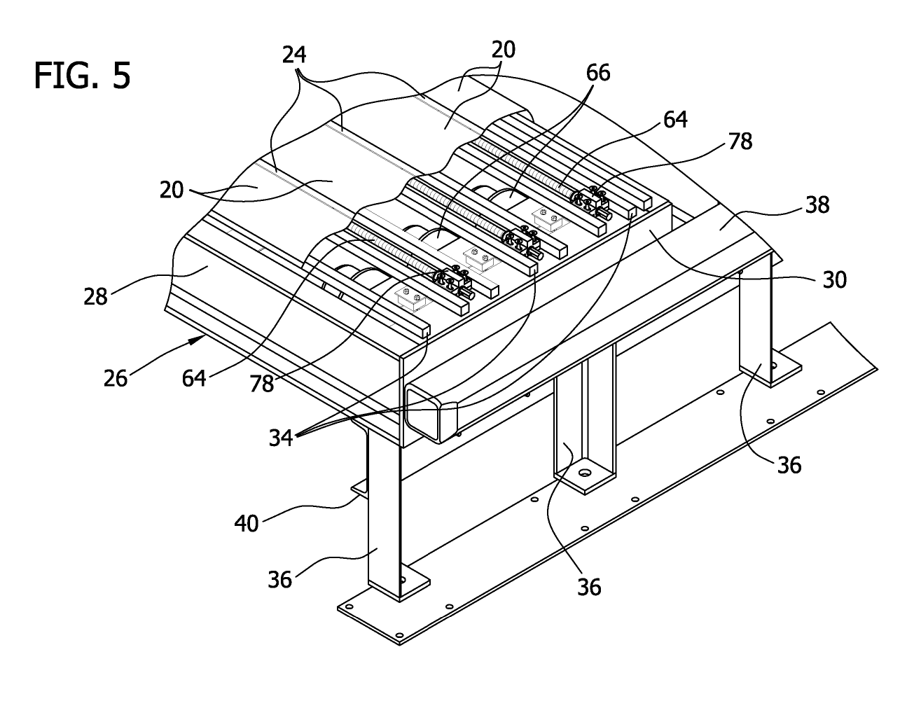

Each plank grouping 22 is supported on the table 12 by a frame, generally indicated at 26. The perimeter of each frame 26 is generally rectangular in shape and formed by two lengthwise extending I-beams 28 (broadly, longitudinal frame supports; only one is visible in FIG. 1) and two transverse L-beams 30 (broadly, transverse frame supports) connected to the ends of the I-beams. It is understood that C-shaped struts or other types of structural members may be used in lieu of the I-beams. As shown in FIG. 3, additional transverse L-beams 32 (broadly, transverse frame supports) extend between the lengthwise I-beams 28 between the ends of the I-beams to provide additional support and stability to the frame 26. As shown in FIGS. 4 and 5, spacers 34 are mounted on upper surfaces of the transverse L-beams 30, 32, and the planks 20 are mounted on the spacers to raise them above the frame 26. In the illustrated table 12, the spacers 34 are welded to the transverse L-beams 30, 32, and the planks 20 are welded to the spacers 34. The transverse L-beams 30, 32, the spacers 34, and the planks 20 may be connected differently, for example with fasteners such as bolts, within the scope of the invention. In the illustrated table 12, the spacers 34 are sized to raise the planks 20 about 2.54 cm (1 in) above the frame 26. The spacers 34 may be sized to raise the planks 20 a different height above the frame 26, for example 3.81 cm (1.5 in), within the scope of the invention.

The frames 26 of the two plank groupings 22 are interconnected to form the table 12, and are supported above the ground by legs 36 (FIGS. 1, 3 and 5). Box beams 38 spanning the ends of the frames 26 provide stability to the frames 26 at the ends of the frames, and C-beams 40 spanning the legs provide additional stability along the legs 36. Multiple tables 12 are typically arranged in alignment during truss fabrication to position the structural components. Truss components (not shown), including for example, bottom chords, upper chords and connecting web members, are arranged using the jig assemblies 14 on and across the tables 12 to form a roof truss. Connector plates are located at the joints of the arranged truss components and, as is known, a gantry press (not shown) that is supported in a suitable manner such as by box beams 38 moves over the truss components to press the connector plates into the truss components to interconnect them.

The jig assemblies 14 of the truss assembly apparatus 10 of the invention are each similar, and only one assembly will be described herein with it understood that a description of each of the other assemblies is substantially the same. As shown best in FIG. 4, each of the jig assemblies 14 is mounted on the table 12 on the transverse L-beams 30, 32 of the frame 26 below the working surface of the planks 20, generally in alignment with one of the respective slots 24 between adjacent planks. In the illustrated truss assembly apparatus 10, three jig assemblies 14 are mounted under each grouping of planks 22 (one for each slot 24) so that six total assemblies are mounted under each table 12. A truss assembly apparatus 10 having more or fewer than six jig assemblies 14 mounted on a truss table 12 are within the scope of the invention.

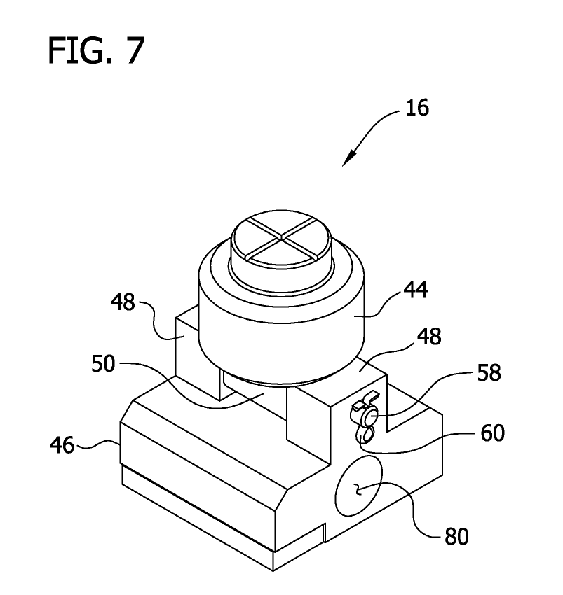

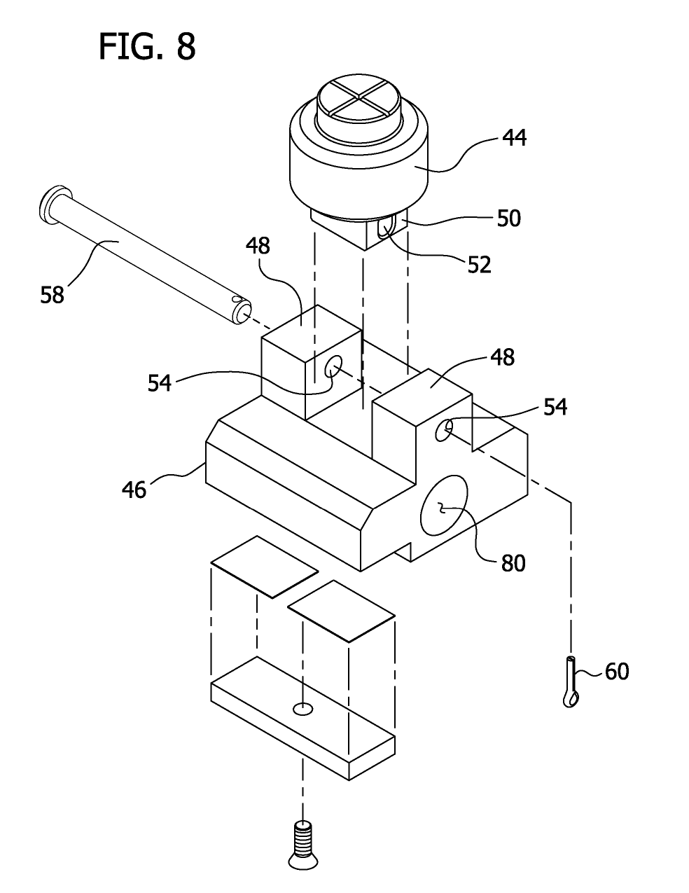

As shown in FIGS. 1, 2 and 6-8, the stop assembly 16 of each jig assembly 14 includes a cylindrically-shaped puck 44 (broadly, a stop) located within one of the slots 24 between adjacent planks 20. The puck 44 projects above the working surface of the table 12 and is longitudinally slidable in translation along the slot 24. As will become apparent, the puck 44 is capable of being fixed in position along the length of the slot 24 for correct location and placement of the truss components. A generally rectangular carrier 46 supports the puck 44 within the slot 24, as is known. As best shown in FIGS. 7 and 8, the carrier 46 includes upstanding, spaced apart arms 48 which receive a mounting portion 50 of the puck therebetween so that openings 52 in the mounting portion align with openings 54 in the arms. A mounting pin 58 extends through the aligned openings 52, 54 to mount the puck 44 on the carrier 46. A cotter pin 60 retains the mounting pin 58 within the openings 52, 54. Other configurations of the carrier 46 and puck 44 may be used within the scope of the present invention.

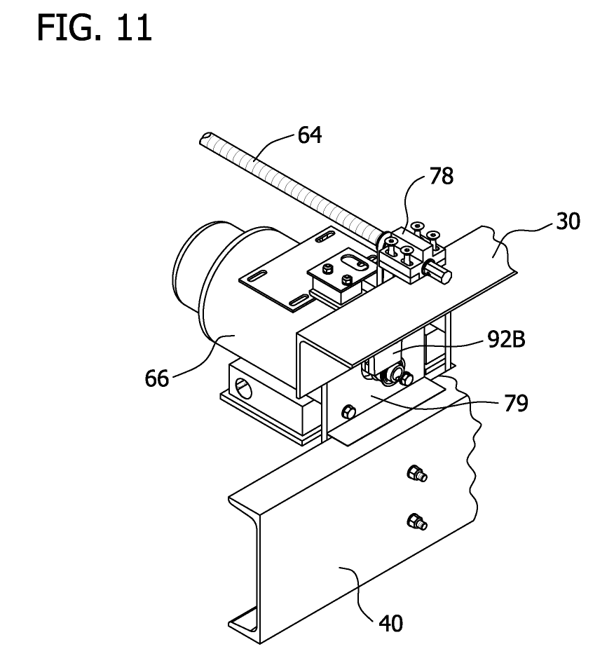

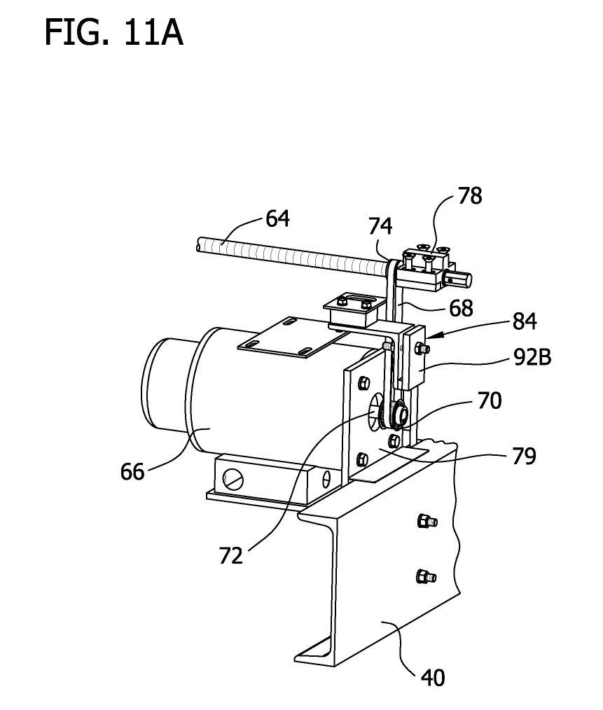

Referring to FIGS. 1, 6, 11 and 11A, the stop assembly 16 is mounted on a rotatable drive screw 64 (broadly, “drive member”) extending longitudinally and in general alignment with the slot 24 within the gap between the frame 26 and the planks 20 formed by the spacers 34. The screw 64 is elongate and extends from one end of the table 12 to the opposite end of the table. An electric motor 66 mounted at one end of the table 12 rotates the screw 64 to impart translational movement of the puck 44 lengthwise along the table 12, as known in the art. As shown in FIG. 11A, a belt 68 extends around a first pulley 70 secured to a rotational output shaft 72 of the motor 66 and around a second pulley 74 secured to the screw 64. The motor 66 is secured to a mounting plate 79 which is mounted on the corresponding perimeter transverse L-beam 30 (FIG. 11) and the C-beam 40 spanning the legs 36 of the table 12. Other ways of affecting rotation of the screw 64, such as a hydraulic or pneumatic motor or a hand crank, and other ways of mounting the motor 66 on the table 12 are within the scope of the invention.

Referring to FIGS. 5, 6, 11 and 11A, bearing housings 78 mounted on the perimeter transverse L-beams 30 of the frame 26 support the screw 64 while allowing it to rotate about its axis during operation. It is understood that the bearing housings 78 can be mounted at other locations other then the L-beams 30. As is generally known, the bearing housings 78 comprise anti-friction bearings that engage the screw 64, but allow the supported screw to rotate relative to the housings. The bearing housing 78 mounted on the end of the table 12 opposite the motor 66 may be adjustable lengthwise of the screw 64 to accommodate small movements of the screw. In other words, this bearing housing 78 may be selectively located within a small distance in a direction along the length screw 64 to ensure the end of the screw is received within the bearing housing.

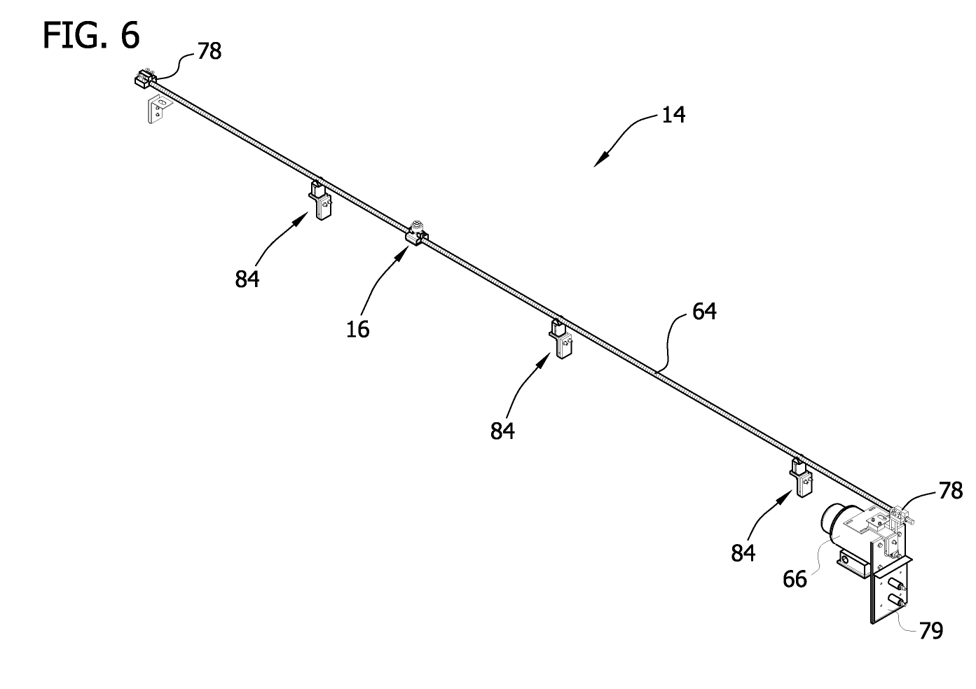

The screw 64 is threaded and receives the carrier 46 thereon through a threaded opening 80 in the carrier (see FIGS. 6 and 7). The screw 64 and the carrier 46 are correspondingly threaded so that rotation of the screw produces translational movement of the carrier along the screw, thus moving the puck in translation along the slot 24. The screw 64 is sized diameter-wise based on the size of the gap between the planks 20 and the frame 26 (i.e., based on the size of the spacers 34 holding the planks above the frame). For example, in the illustrated embodiment the gap is 2.54 cm (1 in) and the screw is about 1.91 cm (0.75 in) in diameter. Other screw sizes may be used within the scope of the invention.

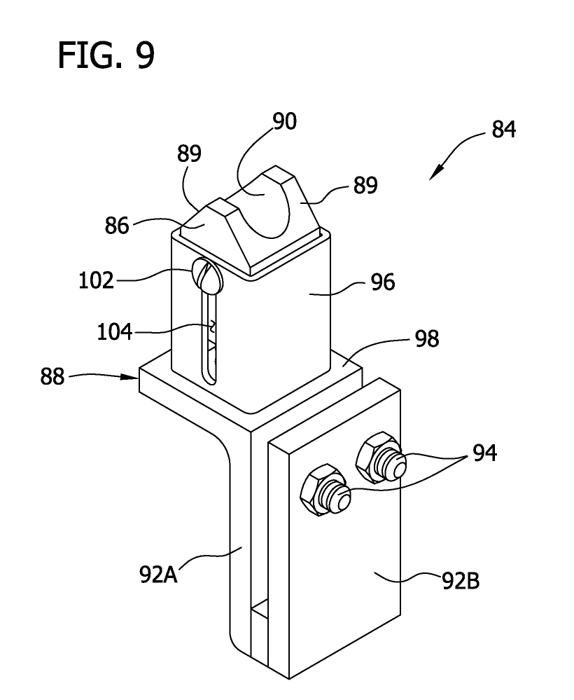

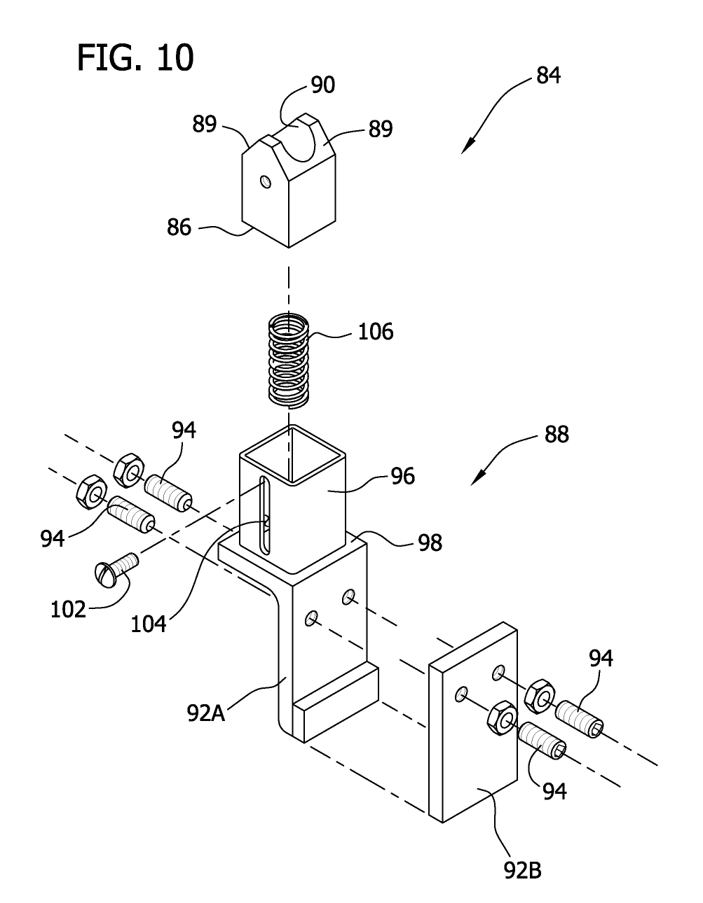

Referring to FIGS. 3, 4, 6, 9 and 10, the drive screw 64 is supported along its length between the bearing housings 78 by adjustable screw supports, each one being generally indicated at 84. In the illustrated jig assembly 14, three adjustable screw supports 84 are used for each screw 64. One of the supports 84 will be described with it understood that a description of the other supports is substantially the same. A different number of supports 84 may be used within the scope of the invention. As shown in FIGS. 9 and 10, each adjustable support 84 generally includes an engagement block 86 (“first portion”) and a mount 88 (“second portion”) supporting the engagement block. The engagement block 86 is a single piece of material having a U-shaped channel 90 formed in an upper end of the block. Opposite faces 89 of the block 86 are beveled. The U-shaped channel 90 receives the screw 64 and provides support to the screw while allowing it to rotate. Particularly, the channel 90 provides both vertical and transverse support to the screw 64 to stabilize it during rotational operation. This reduces wear on the motor 66 and prolongs its operating life, and increases efficiency of the jig assembly 14. It is envisioned that the engagement block 86 is formed from a plastic material capable of supporting the screw 64 while still allowing the screw to rotate without significantly wearing on the block 86. Other suitable materials may be used within the scope of the invention. In addition, an engagement block made from more than one material does not depart from the scope of the invention.

Referring to FIGS. 9-11A, the mount, generally indicated at 88, includes first and second clamp components 92A, 92B, respectively, for securing the mount to the frame 26 of the truss table 12. The clamp components 92A, 92B secure to opposite sides of one transverse L-beam 32 of the frame 26 between the bearing housings 78 and ends of the screw 64. Four threaded compression fasteners 94 are tightened to clamp the first and second components 92A, 92B, respectively, together on the L-beam 32 to secure the mount 88 on the beam. A rectangular mounting tube 96 (broadly, “housing”) is located on a flange 98 of the first clamp component 92A. The engagement block 86 is secured within the tube 96 by a pin or threaded screw 102 (broadly, a retainer) extending through a vertical slot 104 in the tube and into the block. A compression spring 106 (FIG. 10) disposed in the tube 96 between the flange 98 and block 86 urges the block 86 upward so that the U-shaped channel 90 is pressed against the drive screw 64. The screw 102 slides vertically within the slot 104 to allow vertical movement of the engagement block 86 relative to the tube 96. The screw 102 can engage an upper end of the slot 104 to prevent the engagement block 86 from moving out of the tube 96 under the force of the spring 106.

The jig assemblies 14 are intended to be installed on an existing truss table to replace pucks that must be manually positioned. The retrofit jig assemblies 14 can be easily installed on the existing table without dismantling or modifying the table. The adjustable screw supports 84 are connected to transverse L-beams 32 under the table 12, and the bearing housings 78 are connected to the table adjacent to the perimeter L-beams 30. The puck 44 is threaded onto the drive screw 64, and the screw is positioned in the bearing housings 78. The central portions of the screw 64 are supported by the adjustable screw supports 84. The motor 66 is mounted at an end of the table 12 and operatively connected to the screw 64.

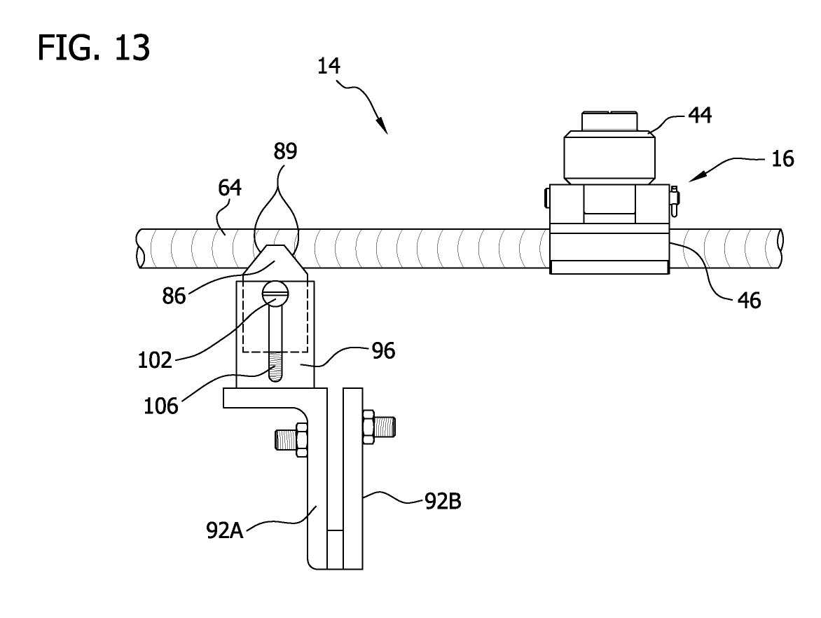

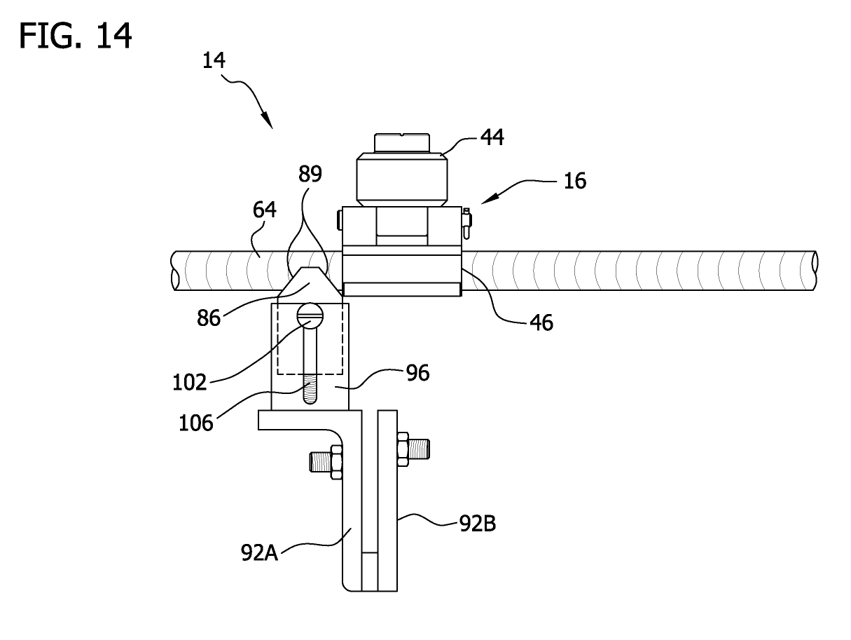

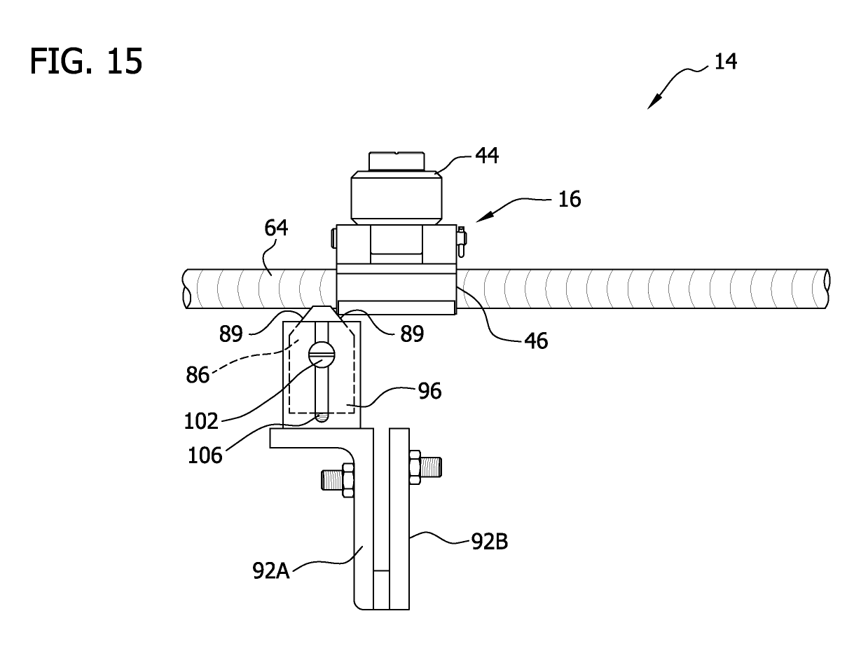

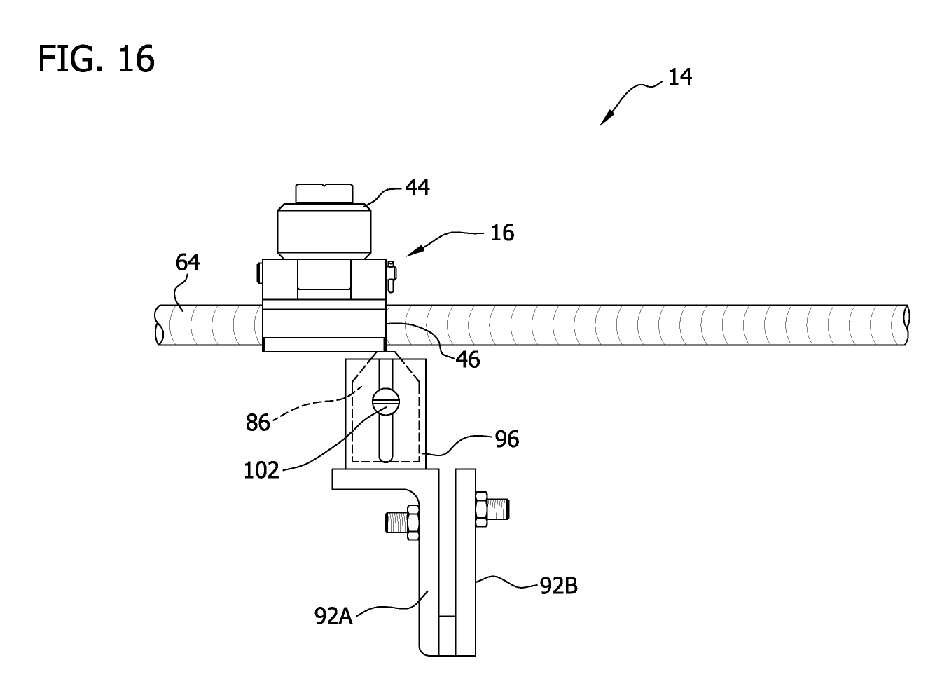

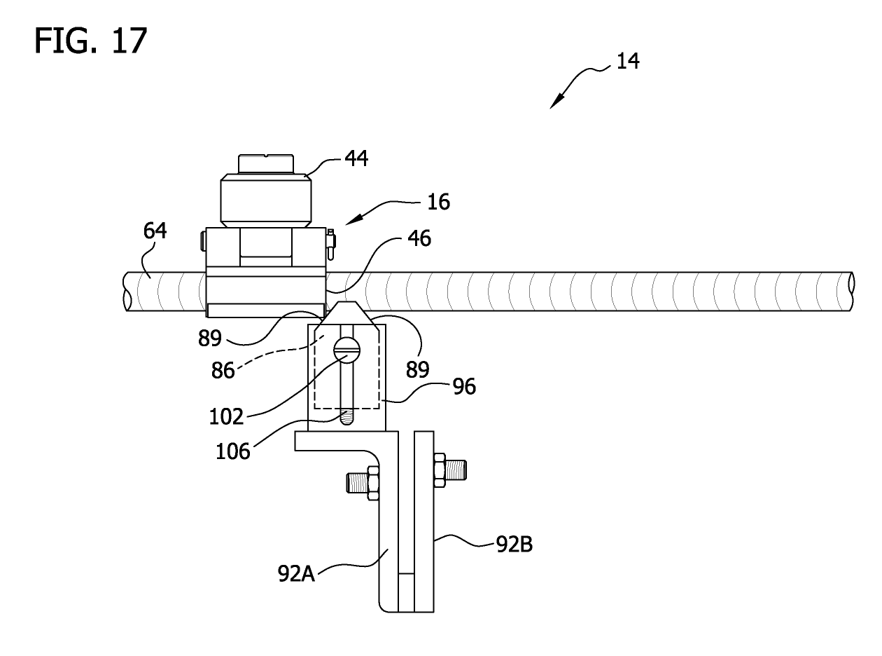

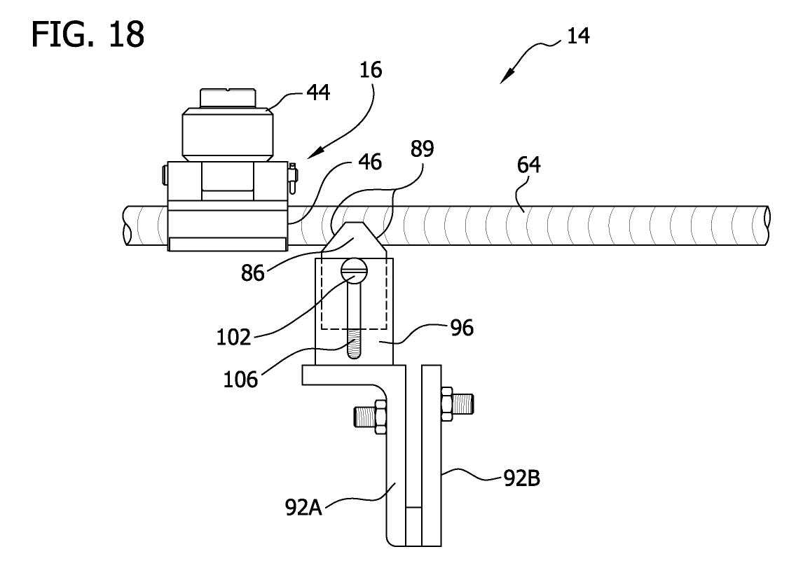

As shown in FIGS. 13-18, in operation of the jig assembly 14, the motor 66 rotates the screw 64 which in turn moves the stop assembly 16 along the table 12. In FIGS. 13-18, the portion of the engagement block 86 within the mounting tube 96 of the adjustable support 84 is illustrated by broken lines. When the carrier 46 of the stop assembly 16 encounters one of the adjustable screw supports 84, the carrier engages one of the beveled faces 89 of the engagement block 86 (FIG. 14). The carrier 46 continues to move along the length of screw 64 so that the carrier rides along the beveled faces 89 of the block 86 and pushes the block downward into the mounting tube 96 (FIG. 15). At this point, the carrier 46 rests on the support 84, and the support supports the screw 64 thru the carrier. As the carrier 46 moves over the engagement block 86, it holds the engagement block in the tube 96 (FIG. 16). As the carrier 46 moves down the opposite beveled face 89 of the support 84, the spring 106 in the mounting tube 96 urges the engagement block 86 out of the tube (FIG. 17) and back into position supporting the screw 64 (FIG. 18). It is understood that when one of the adjustable supports 84 releases the screw 64, the other supports provide adequate support for the screw so that operation is not adversely affected by movement of the carrier 46 past one of the adjustable supports.

It is envisioned that other forms of adjustable supports (not shown) may be used with the jig assembly 14 described herein within the scope of the invention. Other supports that allow a carrier to move past the supports without interference are contemplated. For example, and without limitation, an adjustable support having a pair of opposing arms (i.e., arms separated by 180 degrees) may be used. In this adjustable support, one of the arms supports a screw while the other arm is out of engagement with the screw. As the carrier moves past the support, the carrier rotates the engaging arm out of contact with the screw and rotates the other arm into contact, thus providing continued support to the screw.

In view of the above, it will be seen that the several features of the invention are achieved and other advantageous results obtained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A jig system for use with a truss assembly table having multiple planks extending lengthwise along the table, the jig system comprising:
at least one stop arranged for lengthwise movement along the truss assembly table between adjacent planks of the table;
a support member mounted on the truss assembly table for supporting the stop between the adjacent planks, the support member being adjustable to allow the stop to move past the support member without interference.

2. A jig system as set forth in claim 1 wherein the support member comprises a first portion and a second portion, the first portion being moveable relative to the second portion to allow the stop to move past the support member.

3. A jig system as set forth in claim 2 wherein the support member further comprises a biasing member controlling movement of the first portion relative to the second portion.

4. A jig system as set forth in claim 3 wherein the second portion comprises a housing for receiving the first portion.

5. A jig system as set forth in claim 4 wherein the biasing member is disposed in the housing for urging the first portion to move out of the housing.

6. A jig system as set forth in claim 5 wherein the second portion comprises a clamp for fixedly mounting the support member on the truss table.

7. A jig system as set forth in claim 4 wherein the stop engages the first portion of the support member when the stop moves past the support member.

8. A jig system as set forth in claim 7 wherein the second portion comprises a flange supporting the housing, the stop moving the first portion toward the flange when the stop engages the first portion.

9. A jig system as set forth in claim 8 wherein the biasing member urges the first portion away from the flange of the second portion when the stop disengages the first portion.

10. A jig system as set forth in claim 4 wherein the first portion comprises a retainer and the housing of the second portion comprises an elongate opening, the retainer extending through said elongate opening for moveably securing the first portion in the housing.

11. A jig system as set forth in claim 10 wherein the retainer is a screw formed separate from the first portion and attached thereto.

12. A jig system as set forth in claim 2 further comprising a screw extending along the truss assembly table, the screw moving the stop lengthwise along the table.

13. A jig system as set forth in claim 12 wherein the first portion of the support member comprises channel for receiving the screw on the support member, the stop engaging the first portion of the support member and moving the first portion relative to the second portion when the screw moves the stop past the support member.

14. A jig system as set forth in claim 13 wherein the first portion comprises angled engagement surfaces, the stop engaging the first portion at said engagement surfaces and camming the first portion relative to the second portion of the support member.

15. A jig system as set forth in claim 14 further comprising a motor for driving the screw to move the stop lengthwise along the table.

16. A jig system as set forth in claim 15 comprising three support members.

17. A jig system as set forth in claim 12 wherein the screw is threaded and the stop has a correspondingly threaded opening therein for receiving the screw, the threaded screw moving the stop lengthwise along the table.

18. A jig system as set forth in claim 1 in combination with the truss assembly table.

19. A truss assembly apparatus comprising:
a jig assembly table having multiple planks fixedly attached to a frame;
a retrofit jig system mounted on the truss assembly table, the jig system being mounted without removing planks from the table, the jig system comprising:
a stop member arranged for lengthwise movement along the truss assembly table between adjacent planks of the table;
a drive member mounted on the table for moving the stop member along the table;
a support member mounted on the truss assembly table for supporting the drive member and stop member.

20. A jig assembly system as set forth in claim 19 wherein the support member is adjustable.

21. A jig assembly system as set forth in claim 20 wherein the drive member comprises a screw supported by the adjustable support member.

22. A jig assembly system as set forth in claim 21 further comprising a puck having a threaded opening, the puck receiving the screw through the opening for movement along the screw.

23. A jig assembly system as set forth in claim 22 wherein the puck engages the support member as it moves along the screw and adjusts the support member to allow the puck to move past the support member.

24. A method for retrofitting a truss assembly table with a jig system, the method comprising:
mounting a drive member on the table and a stop member moveable by the drive member on the table;
mounting a support on the table for supporting the drive member.
